(19) United States
(12) Patent Application Publication
(10) Pub. No.: US 2016/0343324 A1
(43) Pub. Date: Nov. 24, 2016

(54) DRIVING APPARATUS, DISPLAY APPARATUS, AND ELECTRONIC APPARATUS

(71) Applicant: CANON KABUSHIKI KAISHA, Tokyo (JP)

(72) Inventor: Shoji Ichimasa, Utsunomiya-shi (JP)

(21) Appl. No.: 15/147,068

(22) Filed: May 5, 2016

(30) Foreign Application Priority Data
May 18, 2015 (JP) 2015-100797

(51) Int. Cl. G09G 3/36

(52) U.S. Cl. CPC G09G 3/3648; G09G 2320/066; G09G 2320/0233; G09G 2320/0673; G09G 2310/0294; G09G 2310/066

(57) ABSTRACT

A driving apparatus includes a contrast controller configured to repeat a bright display and a dark display having a display tone lower than the bright display every one frame in the plurality of pixels. In a driving mode in which the contrast controller repeats the bright display and the dark display, the common voltage controller provides different values to the common voltage in applying the voltage to the same pixel electrode between a first bright display frame that provides the bright display just before a frame for the dark display and a second bright display frame that provides the bright display just after the frame for the dark display.

### BACKGROUND OF THE INVENTION

1. Field of the Invention

The present invention relates to a display apparatus configured to display an image using an electro-optical change, such as a liquid crystal display.

2. Description of the Related Art

One conventional liquid crystal display apparatus uses an active matrix substrate, and provides voltage AC driving of a common electrode (ITO electrode) in one frame so as to inverse the liquid crystal driving voltage a plurality of times. This AC driving can lower an output of an input signal and restrain the manufacturing cost.

Japanese Patent Laid-Open No. 2005-70540 discloses a liquid crystal display apparatus configured to switch the voltage applied to the ITO electrode (referred to as “ITO voltage” hereinafter) in one frame a plurality of times. JP 2005-70540 discloses a driving method for setting a high ITO voltage for odd number frames (referred to as “odd frames” hereinafter), and a low ITO voltage for even number frames (referred to as “even frames” hereinafter).

As disclosed in JP 2005-70540, the liquid crystal driving method for switching the ITO voltage in one frame a plurality of times for each set time period switches the state of the liquid crystal driving voltage for each frame, symmetrizes voltage changes of two continuous frames, and prevents a bias of the liquid crystal driving voltage.

However, the contrast driving (black insertion) for improving the visibility of a motion image makes asymmetrical the voltage changes of respective frames and causes the liquid crystal driving voltage to be biased. Thereby, the transverse band may be visually confirmed and the liquid crystal is deteriorated by burning.

### SUMMARY OF THE INVENTION

The present invention provides a driving apparatus that can prevent the image quality from deteriorating even in contrast driving.

A driving apparatus according to one aspect of the present invention is configured to drive a display apparatus. The display apparatus includes a plurality of scanning lines and a plurality of data lines that are arranged in a matrix shape, and a pair of charge accumulating devices configured to apply a voltage to a pixel electrode in a pixel contained in a pixel column corresponding to the scanning lines via the data lines when a voltage is applied to the scanning lines. The driving apparatus includes a common voltage controller configured to switch a common voltage applied to a common electrode between two different values for each constant time period in one frame, a pixel voltage controller configured to switch the pair of charge accumulating devices connected to the pixel electrode for each constant time period and to control the voltage applied to the pixel electrode, and a contrast controller configured to repeat a bright display and a dark display having a display tone lower than the bright display every one frame in the plurality of pixels. In a driving mode in which the contrast controller repeats the bright display and the dark display, the common voltage controller provides different values to the common voltage in applying the voltage to the same pixel electrode between a first bright display frame that provides the bright display just before a frame for the dark display and a second bright display frame that provides the bright display just after the frame for the dark display.

Further features of the present invention will become apparent from the following description of exemplary embodiments with reference to the attached drawings.

### BRIEF DESCRIPTION OF THE DRAWINGS

FIG. 1 is a block diagram illustrating a structure of a display apparatus according to this embodiment of the present invention.

FIG. 2 is a view illustrating a structure of a pixel in a display apparatus according to first and second embodiments.

FIG. 3 is a timing chart illustrating the timing in horizontal scanning in a driving apparatus according to the first and second embodiments.

FIG. 4 is a timing chart illustrating an operation of a ramp voltage generating circuit including a D/A converter in the driving apparatus according to the first and second embodiments.

FIG. 5 is a view illustrating a voltage control of a ramp signal for video line data in the display apparatus according to the first and second embodiments.

FIG. 6 is a view for explaining the ramp signal voltage and the ITO voltage applied to the pixel in the display apparatus according to the first and second embodiments.

FIGS. 7A and 7B illustrate the liquid crystal driving voltage when the ITO voltage is proper.

FIGS. 8A and 8B illustrate the liquid crystal driving voltage when the ITO voltage shifts.

FIG. 9 is a view illustrating the liquid crystal driving voltage in the display apparatus according to the first embodiment.

FIGS. 10A and 10B are views for explaining a display state when the ITO voltage shifts.

FIG. 11 is a flowchart illustrating a setting operation of contrast driving in the display apparatus according to the first and second embodiments.

FIG. 12 is a view illustrating the liquid crystal driving voltage in the display apparatus according to the second embodiment.

### DESCRIPTION OF THE EMBODIMENTS

Referring now to the accompanying drawings, a description will be given of embodiments of the present invention.

### First Embodiment

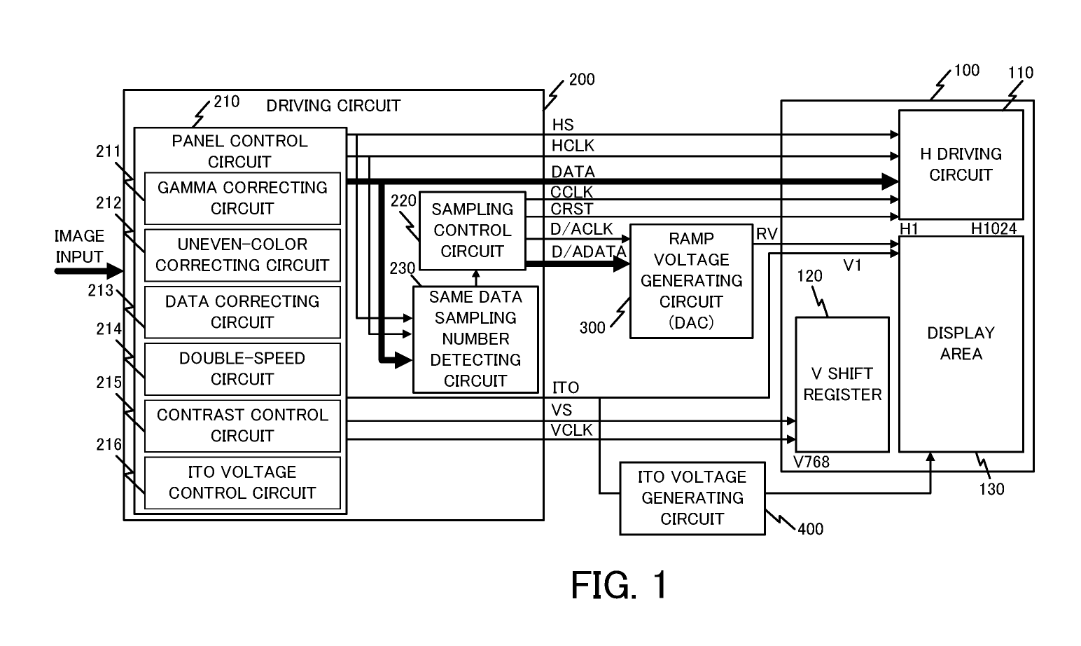

FIG. 1 illustrates a structure of an electro-optical display apparatus according to a first embodiment of the present invention. The electro-optical display apparatus includes a liquid crystal panel 100 as a display unit, a driving circuit 200, and a ramp voltage generating circuit 300 as a voltage generator. The liquid crystal panel 100 displays an image in a display area 130 that includes a plurality of pixels, such as 1024 horizontal pixels×768 vertical pixels corresponding to the XGA resolution.

The electro-optical display apparatus according to this embodiment is installed in a variety of electronic apparatus, such as a liquid crystal projector, a liquid crystal television, a cellular phone, a laptop personal computer, a digital still camera, and a car navigator.

A panel control circuit 210 in the driving circuit 200 generates a driving control signal over a liquid crystal panel 100 in response to a digitized image input from an unillustrated scaler. The panel control circuit 210 includes a gamma correcting circuit 211, an uneven-color correcting circuit 212, and other correcting circuit, and provides a variety of corrections, such as a gamma correction and an uneven-color correction, to an input image signal. The panel control circuit 210 includes a double-speed circuit 214, a contrast control circuit 215, and ITO voltage control circuit (common voltage control circuit) 216.

A same data sampling number detecting circuit 230 as a sampling number detector detects the number of pixels in which the same display tone data (referred to as “the same data” hereinafter) is set, based on image data that has undergone a variety of corrections in the panel control circuit 210, such as the gamma correction and the uneven-color correction. The number of pixels in which the same data is set will be referred to as “the same data sampling number” in the following description.

A sampling control circuit (pixel voltage controller) 220 as a controller controls a voltage generation in the ramp voltage generating circuit 300 and driving of the liquid crystal panel 100, based on the same data sampling number detected by the same data sampling number detecting circuit 230.

The liquid crystal panel 100 includes a display area 130, an H driving circuit 110, and a V shift register 120 as a scanning line driving circuit. The H driving circuit 110 drives a pixel in each horizontal pixel column (referred to as a “pixel line” hereinafter) included in the display area 130 in accordance with a driving control signal and image data from the panel control circuit 210, and a driving control signal from the sampling control circuit 220.

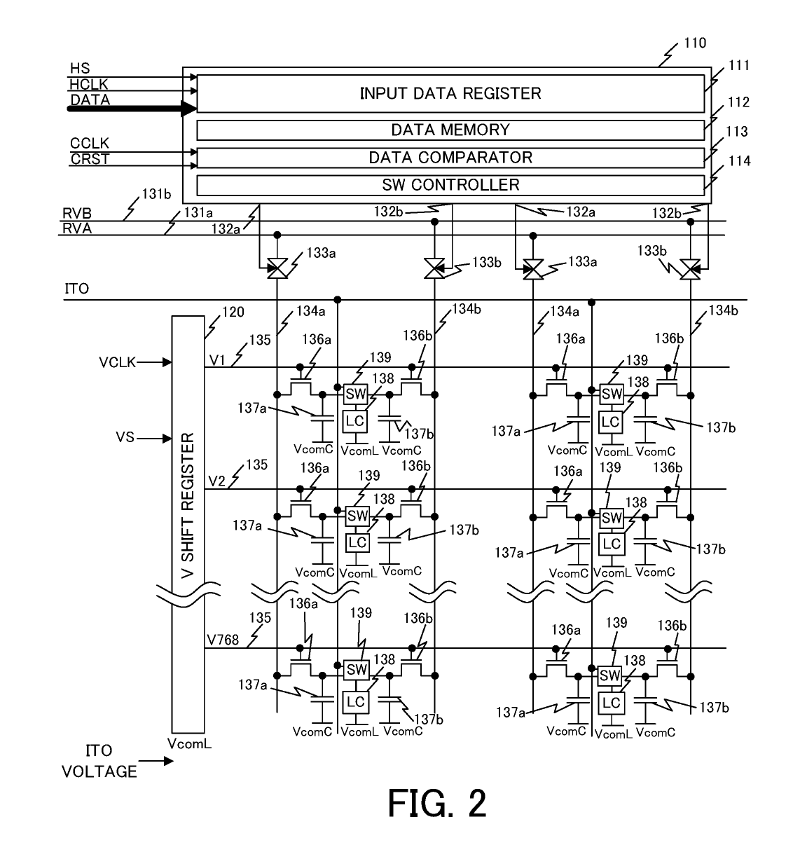

The input data register 111 in the H driving circuit 110 in FIG. 2 sequentially receives image data that has undergone a variety of corrections in the panel control circuit 210, such as the gamma correction and the uneven-color correction, and stores the image data for N+1 lines.

The data memory 112 in the H driving circuit 110 stores N-th line image data received by the input data register 111. The data comparator 113 compares the image data stored in the data memory 112 with a count value CCLK as counter clock (sampling clock) input to the data comparator 113.

The SW controller 114 converts and outputs, based on an output from the data comparator 113, voltages of a SW signal A 132a and a SW signal B 132b for switching analog SWA 133a and analog SWB 133b as data line switches. This voltage conversion switches turning on and off of the analog SWA 133a and analog SWB 133b.

The ramp voltage generating circuit 300 generates ramp voltages RVA 131a and RBV 131b as sampling voltages that can be supplied to a plurality of video lines 134a and 134b. The analog SWA 133a and analog SWB 133b are used to control supplying ramp voltages RVA 131a and RVB 131b to the video lines 134a and 134b as a plurality of data lines arranged so as to extend in the vertical direction of the display area 130. In the XGA resolution, the display area 130 contains 1024 video lines 134a and 134b, and analog SWA 133a and analog SWB 133b are provided for each video line.

The V shift register 120 receives a VS signal and a VCLK signal from the panel control circuit 210, and controls outputting of the V scanning signal (selection voltage) to a plurality of horizontal scanning lines 135 arranged in the horizontal direction of the display area 130. In the XGA resolution, the display area 130 contains 768 horizontal scanning lines 135. The ramp voltages RVA 131a and RVB 131b are generated so as to monotonously change in a period in which the V scanning signal is applied to one horizontal scanning line 135. The V shift register 120 and the analog SWA 133a and analog SWB 133b constitute a voltage sampling unit.

The video lines 134a and 134b and the horizontal scanning line 135 are arranged in a matrix shape. A pixel transistors 136a and 136b as a pair of charge accumulating devices, pixel capacitors 137a and 137b, and a liquid crystal 138 (pixel) are provided to a node at which each horizontal scanning line 135 crosses each video line 134a or 134b.

The ramp voltages RVA 131a and RVB 131b supplied to the video lines 134a and 134b via the analog SWA 133a and analog SWB 133b are connected to the drains in the pixel transistors 136a and 136b. Thereby, the gates of the pixel transistors 136a and 136b are connected to the horizontal scanning line 135, and the V scanning signal from the horizontal scanning line 135 controls turning on and off of the pixel transistors 136a and 136b.

The pixel capacitors 137a and 137b are connected to the sources in the pixel transistors 136a and 136b, receive the ramp voltages applied to the video lines 134a and 134b, and charge the ramp voltages as the pixel voltage. The video lines 134a and 134b are connected to the sources of the pixel transistors 136a and 136b and the video lines 134a and 134 serve as capacitances, forming capacitances larger by several hundreds to tens of thousands than those of the pixel capacitors 137a and 137b. The other ends of the pixel capacitors 137a and 137b are connected to a predetermined voltage VcomC.

The liquid crystal 138 (pixel) is driven by a potential difference that is a difference between a pixel voltage charged in the pixel capacitors 137a and 137b and applied to an unillustrated a pixel electrode and the ITO voltage (common voltage) VcomL applied to a transparent electrode (ITO electrode or a common electrode).

This embodiment adopts the so-called normally black mode of liquid crystal driving method in which the light transmittance of the liquid crystal 138 is minimum and black is displayed when the liquid crystal driving voltage (voltage effective value) becomes nearly zero, and the light transmittance increases as the liquid crystal driving voltage increases.

Referring now to FIGS. 1 and 2, a detailed description will be given of an operation of the liquid crystal panel 100 and the ramp voltage generating circuit 300.

The panel control circuit 210 in the driving circuit 200 has a double-speed circuit 214. For example, when the image input signal has 60 frames per one second, a panel driving signal, a data signal, a driving timing signal and are generated at 120 Hz so as to display two frames of display data in a one-frame time period of the input signal. In outputting one frame of the image signal in a form of two frames, assume that a frame that is output first is set to an odd frame and a frame that is output next is set to an even frame. The panel control circuit 210 has a contrast control circuit 215, which can arbitrary change a gain of the image in the odd and even frames generated by the double-speed circuit 214. For example, if a gain of the odd frame is set to 1 and a gain of the even frame is set to 0, then the black insertion driving (contrast driving) is available.

As described above, the panel control circuit 210 receives an image input and generates image data that has undergone a variety of corrections, such as the gamma correction and the uneven-color correction, at the gamma correcting circuit 211, the uneven-color correcting circuit 212, and the data correcting circuit 213. The generated image data is input to the H driving circuit 110 in the liquid crystal panel 100 via the DATA line, and input into the same data sampling number detecting circuit 230 in the driving circuit 200.

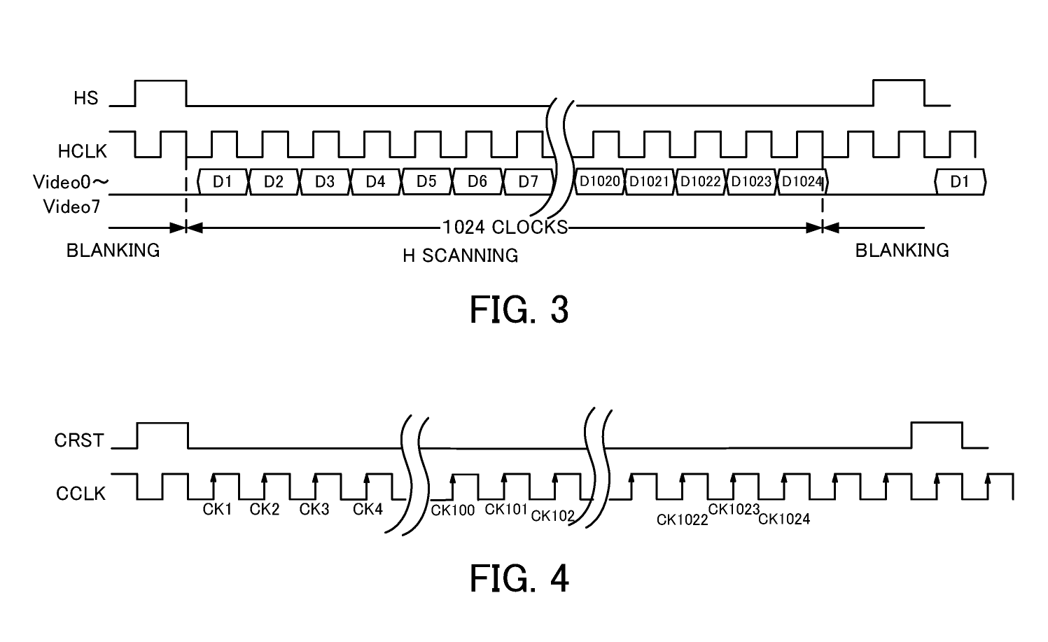

The image data input to the H driving circuit 110 is stored in the input data register 111 in the H driving circuit 110. FIG. 3 illustrates this state. The input data register 111 stores the image data as data D1 to D1024 in synchronization with HCLK starting from the HS signal as the horizontal start signal from the panel control circuit 210. In the XGA resolution, 1024 data are stored as the image data in the horizontal direction.

The data memory 112 stores image data of the N-th line received from the input data register 111. At this time, the next line or (N+1)-th image data is input into the input data register 111.

The data comparator 113 includes, as illustrated in FIG. 4, a counter that counts CCLK starting from the CRST signal output from the sampling control circuit 220. The data comparator 113 compares the image data stored in the data memory 112 with the count value counted by the counter.

For example, when the image data has a 10-bit tone and D1 data is 100, the data comparator 113 provides a comparator output to the SW controller 114 at CK 100. For example, when D2 data is 800, the data comparator 113 provides a comparator output to the SW controller 114 at CK 800. Thus, the data comparator 113 can provide 1024 comparator outputs in the horizontal direction.

The SW controller 114 converts the voltage of the 1024 comparator outputs from the data comparator 113, and outputs a control signal to 1024 pairs of analog SWA 133a and analog SWB 133b. Control turning on and off of the analog SWA 133a and analog SWB 133b can provide controls over the application and cutoff of the ramp voltages RVA 131a and RVA 131b for the video lines 134a and 134b.

All of the 1024 pairs of analog SWA 133a and analog SWB 133b are turned on by the CRST signal. Thereby, the ramp voltages RVA 131a and RVB 131b are applied to the video lines 134a and 134b. The analog SWA 133a and analog SWB 133b are turned off when receiving the comparator output, and the ramp voltages RVA 131a and RVB 131b are not applied to the video liens 134a and 134b (in the cutoff state).

Next follows a description of a generation of a ramp voltage in the ramp voltage generating circuit 300. This embodiment uses for the ramp voltage generating circuit 300 a D/A converter configured to convert digital data into analog data. The sampling control circuit 220 inputs D/ACLK as a clock for updating data of the D/A converter and D/ADATA as data for instructing the D/A converter as the ramp voltage generating circuit 300 to increment the ramp voltage. D/ACLK and D/ADATA are output from the sampling control circuit 220 in synchronization with CCLK starting from the CRST signal.

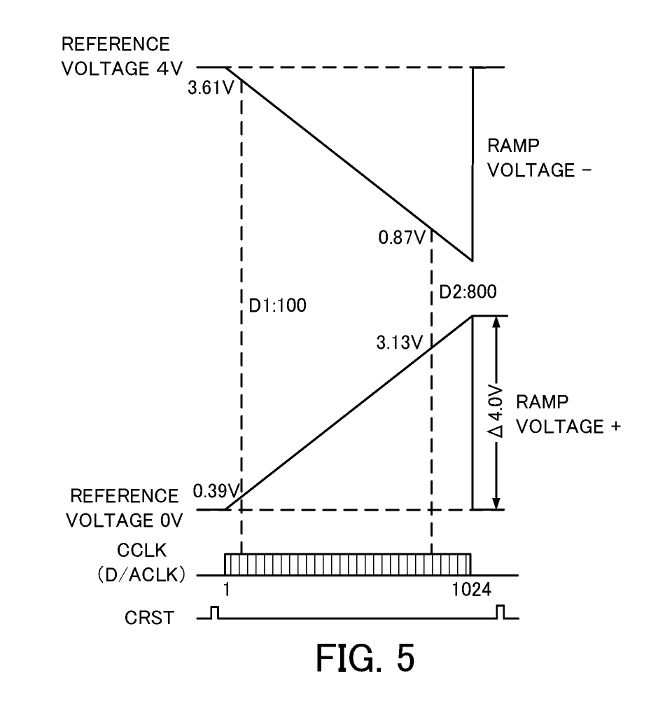

D/ADATA is output from the sampling control circuit 220 as data that increments in accordance with the number of clocks of D/ACLK. For example, the tone of the ramp voltage generating circuit 300 has 10 bits and the ramp voltage generating circuit 300 generates the ramp waveform with 1024 resolutions. As a result, the D/A converter generates a ramp voltage that monotonously changes, as illustrated in FIG. 5.

The ramp voltage+ rises from the reference voltage, such as 0V, as data increments. The ramp voltage− drops from the reference voltage, such as 4V, as the data increments.

The ramp voltages RVA 131a and RVB 131b output from the ramp voltage generating circuit 300 become predetermined onset voltages when the CRST signal inputs. For example, at D1 the voltage “D1:100” is applied as the ramp voltages RVA 131a and RVB 131b to the video lines 134a and 134b in FIG. 5. As described above, when the maximum voltage (A voltage) of the ramp voltage is 4V with the 10-bit tone of the ramp voltage generating circuit 300 and the 1024 resolutions, the ramp voltage RVA 131a at “D1:100” becomes {(100−1)/1023}×4V. Thus, +0.39V for the onset voltage of the ramp voltage+ is applied to the video line 134a. The ramp voltage RVB 131b becomes 4V−{(100−1)/1023}×4V and +3.61V as −0.39V for the onset voltage of the ramp voltage− is applied to the video line 134b.

At D2, the voltage “D2:800” illustrated in FIG. 5 is applied to the video lines 134a and 134b. The ramp voltage RVA 131a illustrated as “D2:800” becomes {(800−1)/1023}×4V, and +3.13V for the onset voltage of the ramp voltage+ is applied to the video line 134a. The ramp voltage RVB 131b becomes 4V−{(800−1)/1023}×4V and 0.87V as −3.13V for the onset voltage of the ramp voltage− is applied to the video line 134b.

By sampling with the ramp voltages, the sampled voltage (pixel voltage) is applied to 1024 pairs of video lines 134a and 134b. The voltages applied to the video lines 134a and 134b are connected to 1024 pairs of pixel transistors 136a and 136b in one line (in H1 to H1024) based on the V scanning signal output from the V shift register 120. Thereby, the 1024 pairs of pixel transistors 136a and 136b are turned on. As a result, the video lines 134a and 134b and pixel capacitors 137a and 137b are connected to each other via the pixel transistors 136a and 136b. The pixel voltages sampled from the ramp voltages RVA 131a and RVB 131b are changed in the pixel capacitors 137a and 137b. The liquid crystal 138 is driven by the pixel voltage charged in the pixel capacitors 137a and 137b connected to H1 to H1024.

The V shift register 120 that has received the vertical scanning start signal VS and vertical scanning clock signal VCLK from the panel control circuit 210 sequentially scans (selects) the V scanning signal output to the horizontal scanning line 135 from V1 to V768 in the vertical direction for each clock VCLK. This scanning can provide writing (charge) control of the pixel voltage for all pixels of the display area 130 in the liquid crystal panel 100.

Next follows a driving method of the liquid crystal panel 100 according to this embodiment.

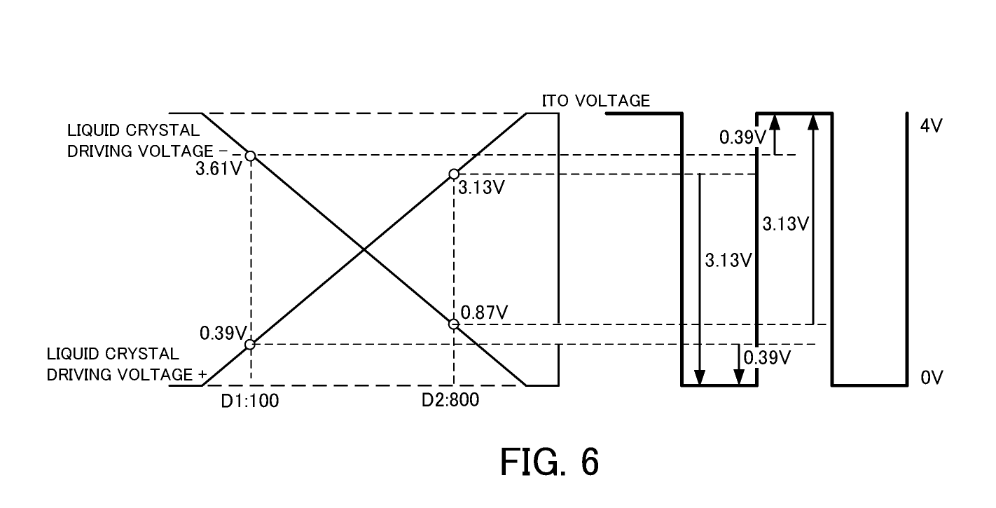

The ITO voltage generating circuit 400 generates the ITO voltage (VcomL) in synchronization with the ITO signal output from the ITO voltage control circuit 216 and applies it to VcomL illustrated in FIG. 2. As illustrated in FIG. 6, the display image of the display area 130 is generated based on a potential difference between the ITO voltage and the voltage charged in the pixel capacitor 137a or 137b.

SW139 in the panel illustrated in FIG. 2 connects one of the pixel capacitor 137a and 137b to the liquid crystal 138 based on the ITO signal output from the ITO voltage control circuit 216 in the panel control circuit 210. This embodiment connects the pixel capacitor 137a to the liquid crystal 138 when the ITO voltage is on a low level (Lo), and the pixel capacitor 137b to the liquid crystal 138 when the ITO voltage is on a high level (Hi).

As illustrated in FIG. 6, in the ITO voltage of Lo and “D1:100,” the pixel voltage of 0.39V by the pixel capacitor 137a is applied to the liquid crystal 138. At this time, the ITO voltage is 0 V and the liquid crystal driving voltage is 0.39V. In the ITO voltage of Hi, the pixel voltage of 3.61V by the pixel capacitor 137b is applied to the liquid crystal 138. At this time, the ITO voltage is 4V and the liquid crystal driving voltage is 0.39V.

In the ITO voltage of Lo and “D2:800,” the pixel voltage of 3.13V by the pixel capacitor 137a is applied to the liquid crystal 138. At this time, the ITO voltage is 0 V and the liquid crystal driving voltage is 3.13V. In the ITO voltage of Hi, the pixel voltage of 0.87V by the pixel capacitor 137b is applied to the liquid crystal 138. At this time, the ITO voltage is 4V and the liquid crystal driving voltage is 3.13V.

In this way, the liquid crystal panel 100 is driven by switching the ITO voltage between Hi and Lo (two different values) at regular intervals a plurality of times in one frame. One of Hi or Lo level is used for one signal in the following description. In other words, when the ITO voltage becomes Hi, Lo, and Hi in this order, the first Hi signal will be referred to as a first signal, the second Lo signal will be referred to as a second signal, and the third Hi signal will be referred to as a third signal.

Next follows a description of the pixel voltage and the ITO voltage where the display pattern is a raster (solid image) of “DATA: 800” (namely, where the pixel voltage by the pixel capacitor 137a is 3.13V and the pixel voltage by the pixel capacitor 137b is 0.87V) in an example. The inversing number of Hi and Lo of the ITO voltage (switching number) depends on the panel, but the switching number is 17 times in one frame for easy description in the following description.

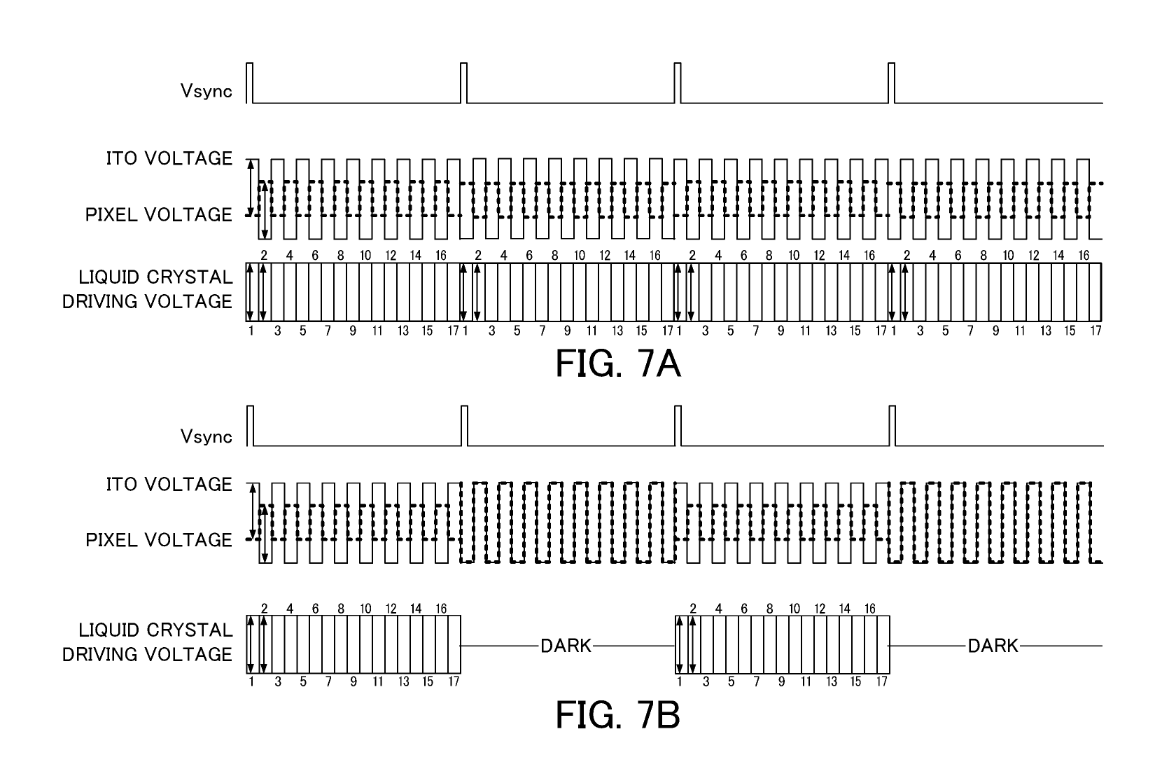

FIG. 7A illustrates a change of the liquid crystal driving voltage in normal liquid crystal driving. The first signal (first ITO voltage) in the first frame driven at 120 Hz is Hi, the ITO voltage of 4V and the pixel voltage of 0.87V by the pixel capacitor 137b are applied to the liquid crystal 138, and the liquid crystal driving voltage is 3.13V. The second signal is Lo in the first frame, the ITO voltage of 0V and the pixel voltage of 3.13V by the pixel capacitor 137a are applied to the liquid crystal 138, and the liquid crystal driving voltage is 3.13V. The ITO voltage is switched 17 times in one frame with switching of the pixel voltage. When the ITO voltage is switched 17 times, the first frame ends and driving of the second frame starts. While driving of the ITO voltage in the first frame starts with Hi, driving of the ITO voltage in the second frame starts with Lo. In the first signal in the second frame (the first ITO voltage in the second frame), the ITO voltage of 0V and the pixel voltage 3.13V by the pixel capacitor 137a are applied to the liquid crystal 138, and the liquid crystal driving voltage is 3.13V. The second signal is Hi, and the ITO voltage of 4V and the pixel voltage of 0.87V by the pixel capacitor 137b are applied to the liquid crystal 138 and the liquid crystal driving voltage is 3.13V.

FIG. 7B illustrates a change of the liquid crystal driving voltage in liquid crystal driving with a black insertion (dark display) so as to improve the visibility of a motion image. Driving in the first frame is similar to driving in FIG. 7A.

In the second frame, this embodiment sets the image data to “DATA: 0” for the black display (dark display), and sets the gain to 0. Therefore, 0V is charged in the pixel capacitor 137a, and 4V is charged in the pixel capacitor 137b. The first signal in the second frame is Lo, the ITO voltage of 0V and the pixel voltage of 0V by the pixel capacitor 137a are applied to the liquid crystal 138, and the liquid crystal driving voltage is 0V. The second signal in the second frame is Hi, the ITO voltage of 4V and the pixel voltage of 4V by the pixel capacitor 137b are applied to the liquid crystal 138, and the liquid crystal driving voltage is 0V. The bright odd frame and the dark even frame are repeated in the display.

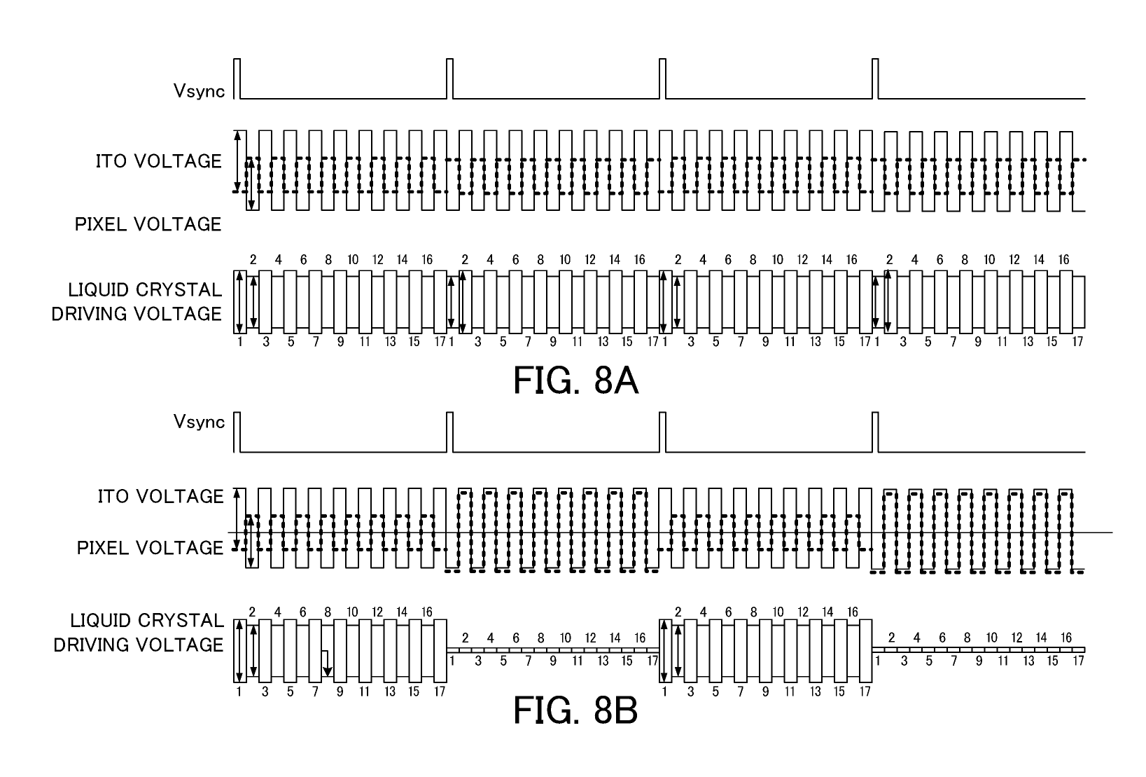

FIGS. 7A and 7B illustrate a case where the ITO voltage has an ideal driving center voltage. In FIGS. 8A and 8B, the center voltage of the ITO driving voltage is not ideal and shifts by 0.05V.

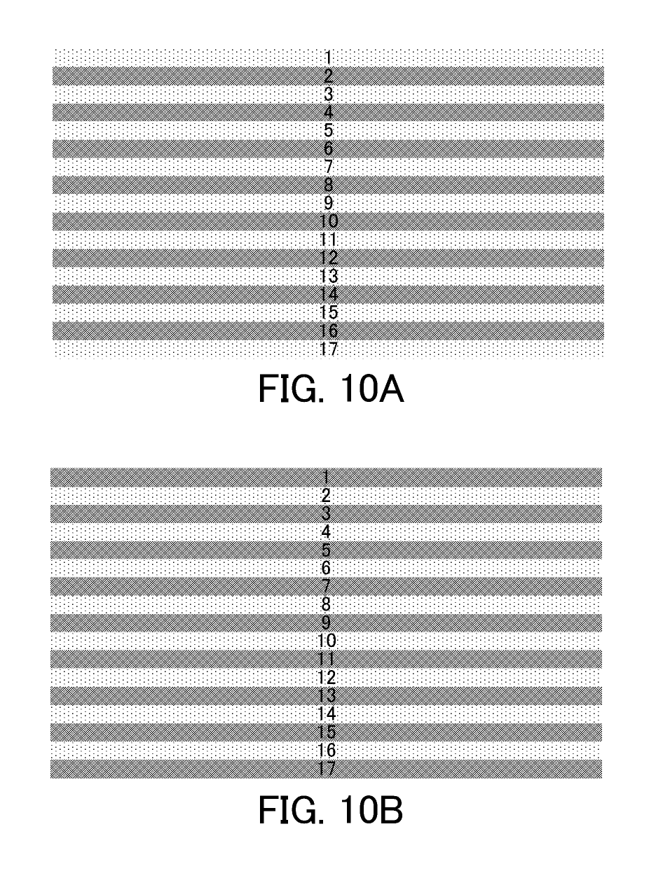

FIG. 8A illustrates a change of the liquid crystal driving voltage in normal liquid crystal driving. The first signal in the first frame is Hi, the ITO voltage of 4.05V and the pixel voltage of 0.87V by the pixel capacitor 137b are applied to the liquid crystal 138, and the liquid crystal driving voltage is 3.18V. The second signal is Lo in the first frame, the ITO voltage of 0.05V and the pixel voltage of 3.13V by the pixel capacitor 137a are applied to the liquid crystal 138, and the liquid crystal driving voltage is 3.08V. The ITO voltage is switched 17 times in one frame with switching of the pixel voltage. When the ITO voltage is switched 17 times, the first frame ends and driving of the second frame starts. The liquid crystal driving voltage differs between the ITO voltage of Hi and the ITO voltage of Lo, and is displayed as a band shape with a different contrast in the transverse direction as illustrated in FIG. 10A.

While driving of the ITO voltage in the first frame starts with Hi, driving of the ITO voltage in the second frame starts with Lo. In the first signal in the second frame, the ITO voltage of 0.05V and the pixel voltage of 3.13V by the pixel capacitor 137a are applied to the liquid crystal 138, and the liquid crystal driving voltage is 3.08V. The second signal in the second frame is Hi, and the ITO voltage of 4.05V and the pixel voltage of 0.87V by the pixel capacitor 137b are applied to the liquid crystal 138, and the liquid crystal driving voltage is 3.18V. The display state in the second frame has a band shape as illustrated in FIG. 10B.

The band shape displays illustrated in FIGS. 10A and 10B are repeated in the liquid crystal driving illustrated in FIG. 8A, and the transverse band that is bright in the first frame is dark in the second frame, and the transverse band that is dark in the first frame is bright in the second frame. This reciprocal display states are repeated for each frame, and the transverse band is not visually confirmed because the contrasts of the transverse bands are averaged between the odd frame and the even frame.

FIG. 8B illustrates a change of liquid crystal driving voltage in liquid crystal driving with black insertion so as to improve the visibility of the motion image. Driving in the first frame (first bright display frame) is similar to driving in FIG. 8A, and the transverse band illustrated in FIG. 10A is displayed.

In the second frame (in a black display period), this embodiment sets the image data to “DATA: 0” for black display, and sets the gain to 0. Therefore, 0V is charged in the pixel capacitor 137a, and 4V is charged in the pixel capacitor 137b. The first signal in the second frame is Lo, and the ITO voltage of 0.05V and the pixel voltage of 0V by the pixel capacitor 137a are applied to the liquid crystal 138, and the liquid crystal driving voltage is 0.05V. The second signal in the second frame is Hi, the ITO voltage of 4.05V and the pixel voltage of 4V by the pixel capacitor 137b are applied to the liquid crystal 138, and the liquid crystal driving voltage is 0.05V. The voltage of 0.05V is applied to the liquid crystal 138, but the liquid crystal 138 displays black due to the VT characteristic of the liquid crystal.

While driving of the ITO voltage in the second frame starts with Lo, driving of the ITO voltage in the third frame (second bright frame) starts with Hi. The pulse waveform in the third frame just after the second frame is the same as that of the first frame just before the second frame. The band shape illustrated in FIG. 10A is displayed for the odd frame, and black is displayed in the even frame.

Therefore, only the transverse band illustrated in FIG. 10A is displayed in the liquid crystal driving illustrated in FIG. 8B, the contrasts of the transverse bands are not averaged, and the transverse band is visually confirmed. The liquid crystal driving voltage is biased and the liquid crystal is deteriorated by burning.

Accordingly, this embodiment drives the liquid crystal as follows.

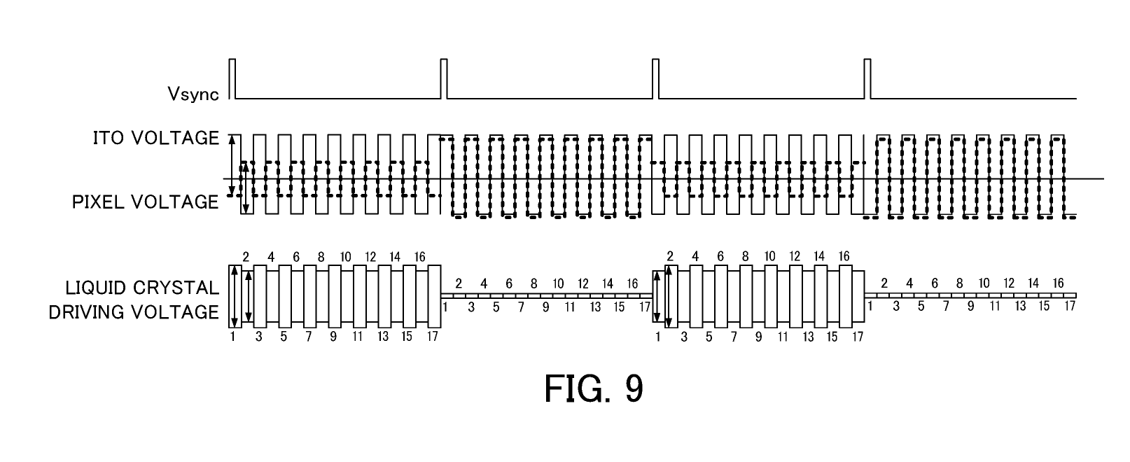

FIG. 9 illustrates a change of the liquid crystal driving voltage in liquid crystal driving according to this embodiment. This liquid crystal driving also inserts black similar to FIG. 8B.

The first frame is driven similarly to FIG. 8A, and the transverse band illustrated in FIG. 10A is displayed.

The second frame is driven starting from the ITO voltage of Hi similarly to the first frame. The first signal for the second frame is continuously Hi from the last signal in the just previous first frame.

In the second frame, this embodiment sets the image data to “DATA: 0” for black display. Therefore, 0V is charged in the pixel capacitor 137a, and 4V is charged in the pixel capacitor 137b. In the first signal in the second frame, the ITO voltage of 4.05V and the pixel voltage of 4V by the pixel capacitor 137a are applied to the liquid crystal 138, and the liquid crystal driving voltage is 0.05V. The second signal in the second frame is Lo, the ITO voltage of 0.05V and the pixel voltage of 0V by the pixel capacitor 137b are applied to the liquid crystal 138, and the liquid crystal driving voltage is 0.05V. The voltage of 0.05V is applied to the liquid crystal 138, but the liquid crystal 138 displays black due to the VT characteristic of the liquid crystal.

While driving of the ITO voltage in the first and second frames starts with Hi, driving of the ITO voltage in the third frame starts with Lo. In the first signal in the third frame, the ITO voltage of 0.05V and the pixel voltage of 3.17V by the pixel capacitor 137a are applied to the liquid crystal 138, and the liquid crystal driving voltage is 3.08V. The second signal in the third frame is Hi, the ITO voltage of 4.05V and the pixel voltage of 0.87V by the pixel capacitor 137b are applied to the liquid crystal 138, and the liquid crystal driving voltage is 3.13V. The display state in the second frame is the transverse band display illustrated in FIG. 10B.

Driving of the ITO voltage in the fourth frame starts with Lo similar to the third frame. The first signal for the fourth frame is continuously Hi from the last signal in the just previous third frame. In the first signal in the fourth frame, the ITO voltage of 0.05V and the pixel voltage of 0V by the pixel capacitor 137b are applied to the liquid crystal 138, and the liquid crystal driving voltage is 0.05V. The second signal in the fourth frame is Hi, the ITO voltage of 4.05V and the pixel voltage of 4V by the pixel capacitor 137a are applied to the liquid crystal 138, and the liquid crystal driving voltage is 0.05V. The voltage of 0.05V is applied to the liquid crystal 138, but the liquid crystal 138 displays black due to the VT characteristic of the liquid crystal.

This embodiment repeats driving of the liquid crystal illustrated in FIG. 9. Where n is a natural integer, this embodiment performs an operation in a (4n−3)-th frame similarly to that in the first frame illustrated in FIG. 9, an operation in a (4n−2)-th frame similarly to that in the second frame illustrated in FIG. 9, an operation in a (4n−1)-th frame similarly to that in the third frame illustrated in FIG. 9, and an operation in a 4n-th frame similarly to that in the fourth frame illustrated in FIG. 9. Thereby, the transverse bands illustrated in FIG. 10A appear in the first frame, the fifth frame, the ninth frame, . . . the (4n−3)-th frame, and the transverse bands illustrated in FIG. 10B appear in the third frame, the seventh frame, the eleventh frame, . . . (4n−1)-th frame. Black is displayed in the even frame.

In other words, in the liquid crystal driving illustrated in FIG. 9, the band displays of FIGS. 10A and 10B are repeated in the odd frames. Thereby, the transverse band that is bright in the (4n−3)-th frame is dark in the (4n−1)-th frame, and the transverse band that is dark in the (4n−3)-th frame is bright in the (4n−1)-th frame. The reciprocal display states are repeated every two frames, and the transverse band is not visually confirmed because the contrasts of the transverse bands are averaged. The liquid crystal is less likely to suffer from burning caused by a biased liquid crystal driving voltage.

The above description accords the pulse waveform of the ITO voltage in the first frame with that in the second frame, and inverses the pulse waveform of the ITO voltage in the third frame to that in the first frame. Alternatively, this embodiment may inverse the pulse waveform of the ITO voltage in the second frame to that in the first frame and accord the pulse waveform of the ITO voltage in the second frame with that in the third frame. In this case, the last signal in the second frame continuously has the same value as that of the first signal in the just previous third frame.

Black is displayed in the even frame, but the display may be darker than that in the odd frame instead of making the gain zero in the even frame.

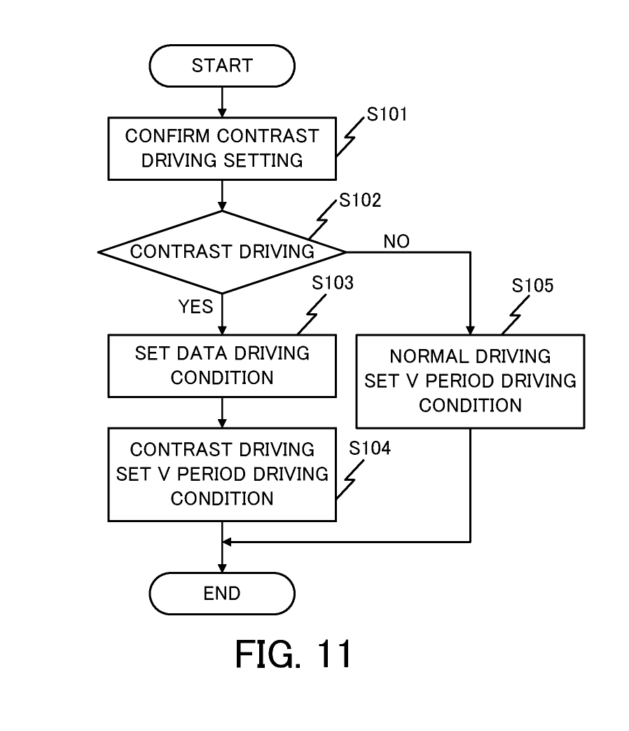

Referring now to FIG. 11, a description will be given of the setting of a driving mode.

In step S101, the panel control circuit 210 confirms a setting state of an unillustrated switch, etc.

Next, in step S102, the panel control circuit 210 determines whether the setting state is a contrast driving mode or a normal driving mode. The panel control circuit 210 moves to step S103 when determining that the setting state is the contrast driving mode, and to step S105 when determining that the setting state is the normal driving mode.

In step S105, the panel control circuit 210 sets the normal driving so as to switch a first signal in each frame between Hi and Lo (two different values) (at regular time intervals), as illustrated in FIG. 8A.

In step S103, the panel control circuit 210 sets a DATA driving condition so as to write down data to brighten the odd frame and darken the even frame, in the pixel capacitors 137a and 137b of the panel, and moves processing to step S104.

In step S104, the panel control circuit 210 sets such a driving condition, as illustrated in FIG. 9, that a first signal in an odd frame is switched between Hi and Lo every two frames.

This setting can properly switch the normal driving mode and the contrast driving mode, and set the appropriate driving condition of the ITO voltage in the contrast driving mode.

According to this embodiment, even when the transverse bands occur due to a shift of the driving center voltage of the ITO voltage in the contrast driving mode (black insertion), the pulse waveforms of the ITO voltage are inversed between the odd frames, the contrasts of the transverse bands are averaged and less likely to be visually confirmed. The liquid crystal is less likely to suffer from burning caused by a biased liquid crystal driving voltage.

### Second Embodiment

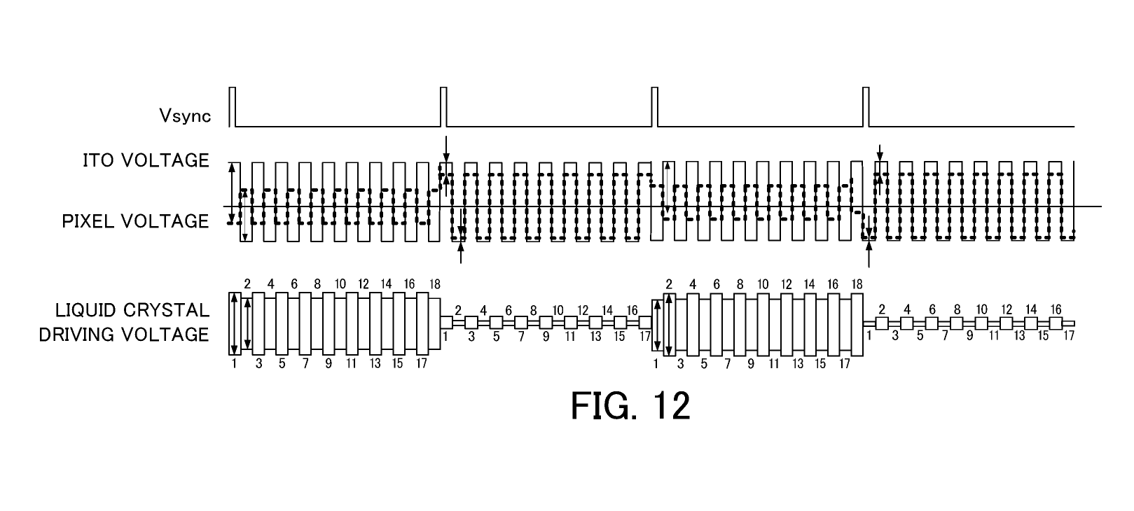

Referring now to FIG. 12, a description will be given of an electro-optical display apparatus according to a second embodiment of the present invention.

The structures of the driving circuit 200, the ramp voltage generating circuit 300, the liquid crystal panel 100, etc. are similar to those of the first embodiment. A description of the other common structure to the first embodiment will be omitted.

This embodiment describes contrast driving for improving the visibility of the motion image as illustrated in FIG. 12. In FIGS. 8B and 9 according to the first embodiment, the gain is set to zero in the even frame but this embodiment sets the gain of the odd frame to 1 and the gain of the even frame to 0.2.

This embodiment provides normal ITO driving that alternately repeats switching of Hi and Lo over all frames even in the contrast driving without control of continuing the same level signal in the frame transfer unlike the first embodiment.

In order to obtain similar effects to those of the first embodiment in this liquid crystal driving, this embodiment switches the ITO voltage only in the odd frame 18 times in the contrast driving, whereas the first embodiment switches the ITO voltage in one frame times. Since driving of the ITO voltage in the first frame starts with Hi, similar to the display illustrated in FIG. 10A, the band shape display is obtained in which the line corresponding to the odd number signal is brighter than the line corresponding to the even number signal.

In the second frame, the liquid crystal is driven by setting Hi switched from Lo of the last signal in the first frame to the twenty-first signal (first ITO voltage in the second frame). For the displayed second frame darker than the first frame, this embodiment sets the image data to “DATA: 200” and charges 0.78V in the pixel capacitor 137a, and 3.22V in the pixel capacitor 137b. In the first signal in the second frame, the ITO voltage of 4.05V and the pixel voltage of 3.22V by the pixel capacitor 137b are applied to the liquid crystal 138, and the liquid crystal driving voltage is 0.83V. The second signal in the second frame is Lo, the ITO voltage of 0.05V and the pixel voltage of 0.78V by the pixel capacitor 137b are applied to the liquid crystal 138, and the liquid crystal driving voltage is 0.73V. Thus, the displayed second frame is darker than the first frame.

In the third frame, the liquid crystal is driven by setting Lo switched from Hi of the last signal in the second frame to the first signal. In the first signal in the third frame, the ITO voltage of 0.05V and the pixel voltage of 3.13V by the pixel capacitor 137a are applied to the liquid crystal 138, and the liquid crystal driving voltage is 3.18V. The second signal in the third frame is Hi, the ITO voltage of 4.05V and the pixel voltage of 0.87V by the pixel capacitor 137b are applied to the liquid crystal 138, and the liquid crystal driving voltage is 3.08V. Similar to the display illustrated in FIG. 10B, the band shape display is obtained in which the line corresponding to the odd number signal is brighter than the line corresponding to the even number signal.

In the fourth frame, the liquid crystal is driven by setting Lo switched from Hi of the last signal in the third frame to the first signal. For displayed fourth frame darker than the third frame, this embodiment sets the image data to “DATA: 200” and charges 0.78V in the pixel capacitor 137a, and 3.22V in the pixel capacitor 137b. In the first signal in the fourth frame, the ITO voltage of 0.05V and the pixel voltage of 0.78V by the pixel capacitor 137a are applied to the liquid crystal 138, and the liquid crystal driving voltage is 0.73V. The second signal in the fourth frame is Hi, the ITO voltage of 4.05V and the pixel voltage of 3.22V by the pixel capacitor 137b are applied to the liquid crystal 138, and the liquid crystal driving voltage is 0.83V. Thus, the displayed fourth frame is darker than the third frame.

This embodiment repeats the liquid crystal driving illustrated in FIG. 12. Where n is a natural integer, this embodiment performs an operation in a (4n−3)-th frame similarly to that in the first frame illustrated in FIG. 12, an operation in a (4n−2)-th frame similarly to that in the second frame illustrated in FIG. 12, an operation in a (4n−1)-th frame similarly to that in the third frame illustrated in FIG. 12, and an operation in a 4n-th frame similarly to that in the fourth frame illustrated in FIG. 12.

Thereby, similar to FIG. 10A, bands appear in the first frame, the fifth frame, the ninth frame, the (4n−3)-th frame, in which a line corresponding to the odd number signal is brighter than a line corresponding to the even number signal. In addition, similar to FIG. 10B, bands appear in the third frame, the seventh frame, the eleventh frame, . . . the (4n−1)-th frame in which a line corresponding to the odd number signal is darker than a line corresponding to the even number signal.

Thus, the reciprocal display states are repeated every two frames, and the transverse bands are less likely to be visually confirmed because the contrasts of the transverse bands are averaged. The liquid crystal is less likely to suffer from burning caused by a biased liquid crystal driving voltage.

While this embodiment switches the ITO voltage in the odd frame even times and the ITO voltage in the even frame odd times, the ITO voltage in the odd frame may be switched odd times and the ITO voltage in the even frame may be switched even times.

The first and second embodiments set the odd frame to be bright and the even frame to be dark in the contrast driving, but may set the odd frame to be dark and the even frame to be bright.

The ITO driving voltage in the first frame may start with Lo. In this case, the pulse waveform of the ITO driving voltage is inversed from those in the above embodiments.

The bright display and dark display may not be switched every one frame, and the dark insertion (dark display) may be made at an arbitrary timing

According to the first and second embodiments, the contrast control circuit change the gain of the image data but can provide a dark display by simply reducing the brightness of the backlight.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-100797, filed May 18, 2015, which is hereby incorporated by reference herein in its entirety.

What is claimed is:

1. A driving apparatus configured to drive a display apparatus, the display apparatus including a plurality of scanning lines and a plurality of data lines that are arranged in a matrix shape, and a pair of charge accumulating devices configured to apply a voltage to a pixel electrode in a pixel contained in a pixel column corresponding to the scanning lines via the data lines when a voltage is applied to the scanning lines, the driving apparatus comprising:
a common voltage controller configured to switch a common voltage applied to a common electrode between two different values for each constant time period in one frame;
a pixel voltage controller configured to switch the pair of charge accumulating devices connected to the pixel electrode for each constant time period and to control the voltage applied to the pixel electrode; and
a contrast controller configured to repeat a bright display and a dark display having a display tone lower than the bright display every one frame in the plurality of pixels,
wherein in a driving mode in which the contrast controller repeats the bright display and the dark display, the common voltage controller provides different values to the common voltage in applying the voltage to the same pixel electrode between a first bright display frame that provides the bright display just before a frame for the dark display and a second bright display frame that provides the bright display just after the frame for the dark display.

2. The driving apparatus according to claim 1, wherein the common voltage in applying the voltage to the same pixel electrode is an initial common voltage in a corresponding frame.

3. The driving apparatus according to claim 1, wherein in the driving mode, the common voltage controller equalizes an initial common voltage in the frame for the dark display to a last common voltage in the first bright display frame.

4. The driving apparatus according to claim 1, wherein in the driving mode, the common voltage controller equalizes a last common voltage in the frame for the dark display to an initial common voltage in the second bright display frame.

5. The driving apparatus according to claim 1, wherein in the driving mode, the common voltage controller equalizes a waveform of the common voltage in the frame for the dark display to that of the common voltage in the second bright display frame.

6. The driving apparatus according to claim 1, wherein in the driving mode, the common voltage controller equalizes a waveform of the common voltage in the frame for the dark display to that of the common voltage in the first bright display frame.

7. The driving apparatus according to claim 1, wherein the common voltage controller provides control such that the common voltage is switched different times in one frame between the frame for the dark display and the second bright display frame.

8. The driving apparatus according to claim 1, wherein the common voltage controller switches the common voltage odd times in one frame in the frame for the dark display, and even times in one frame in the second bright display frame.

9. The driving apparatus according to claim 1, wherein the common voltage controller switches the common voltage odd times in one frame in the frame for the dark display, and even times in one frame in the second bright display frame.

10. The driving apparatus according to claim 1, wherein the pixel voltage controller provides control such that the voltage applied to the same pixel value is different between the first bright display frame and the second bright display frame.

11. A display apparatus comprising:
a plurality of scanning lines and a plurality of data lines that are arranged in a matrix shape;
a pair of charge accumulating devices configured to apply a voltage to a pixel electrode in a pixel contained in a pixel column corresponding to the scanning lines via the data lines when a voltage is applied to the scanning lines; and
a driving apparatus,
wherein the driving apparatus includes:
a common voltage controller configured to switch a common voltage applied to a common electrode between two different values for each constant time period in one frame;
a pixel voltage controller configured to switch the pair of charge accumulating devices connected to the pixel electrode for each constant time period and to control the voltage applied to the pixel electrode; and
a contrast controller configured to repeat a bright display and a dark display having a display tone lower than the bright display every one frame in the plurality of pixels,
wherein in a driving mode in which the contrast controller repeats the bright display and the dark display, the common voltage controller provides different values to the common voltage in applying the voltage to the same pixel electrode between a first bright display frame that provides the bright display just before a frame for the dark display and a second bright display frame that provides the bright display just after the frame for the dark display.

12. An electronic apparatus comprising a display apparatus,
wherein a display apparatus includes:
a plurality of scanning lines and a plurality of data lines that are arranged in a matrix shape;
a pair of charge accumulating devices configured to apply a voltage to a pixel electrode in a pixel contained in a pixel column corresponding to the scanning lines via the data lines when a voltage is applied to the scanning lines; and
a driving apparatus,
wherein the driving apparatus includes:
a common voltage controller configured to switch a common voltage applied to a common electrode between two different values for each constant time period in one frame;
a pixel voltage controller configured to switch the pair of charge accumulating devices connected to the pixel electrode for each constant time period and to control the voltage applied to the pixel electrode; and
a contrast controller configured to repeat a bright display and a dark display having a display tone lower than the bright display every one frame in the plurality of pixels,
wherein in a driving mode in which the contrast controller repeats the bright display and the dark display, the common voltage controller provides different values to the common voltage in applying the voltage to the same pixel electrode between a first bright display frame that provides the bright display just before a frame for the dark display and a second bright display frame that provides the bright display just after the frame for the dark display.
